(19) United States
(12) Patent Application Publication
(10) Pub. No.: US 2010/0103771 A1
(43) Pub. Date: Apr. 29, 2010

(54) PROVIDING A SURVEY CARRIER STRUCTURE HAVING EQUIDISTANT SURVEY SENSORS

(76) Inventors: Espen Gulbransen, Oslo (NO); Vidar Husom, Asker (NO)

Correspondence Address: WesternGeco L.L.C.;Kevin McEnaney, 10001 Richmond Avenue, HOUSTON, TX, 77042-4299, US

(21) Appl. No.: 12/256,536

(22) Filed: Oct. 23, 2008

(51) Int. Cl. G01V 1/20; G01V 1/38

(52) U.S. Cl. 367/17; 367/20

(57) ABSTRACT

A marine survey carrier structure includes sensor assemblies each containing a corresponding set of survey sensors, and an equipment assembly in-line with two of the sensor assemblies. The equipment assembly contains at least one survey sensor to enable the survey sensors along a length of the marine survey carrier structure to be regularly spaced.

### TECHNICAL FIELD

The invention relates generally to providing a survey carrier structure (e.g., a streamer) that has equidistant survey sensors.

### BACKGROUND

Seismic surveying is used for identifying subterranean elements, such as hydrocarbon reservoirs, fresh water aquifers, gas injection reservoirs, and so forth. In performing seismic surveying, seismic sources are placed at various locations above an earth surface or sea floor, with the seismic sources activated to generate seismic waves directed into the subterranean structure. Examples of seismic sources include explosives, air guns, or other sources that generate seismic waves. In a marine seismic surveying operation, the seismic sources can be towed through water.

The seismic waves generated by a seismic source travel into the subterranean structure, with a portion of the seismic waves reflected back to the surface for receipt by seismic receivers (e.g., accelerometers, geophones, hydrophones, etc.). These seismic receivers produce signals that represent detected seismic waves. Signals from seismic receivers are processed to yield information about the content and characteristic of the subterranean structure.

In a marine application, marine vessels are used to tow seismic sources and seismic streamer cables (that carry seismic sensors) through a body of water. In some implementations, a streamer includes navigation equipment (e.g., steerable birds that have fins to steer the streamer) in addition to the seismic sensors. The navigation equipment may also further include an acoustic device to perform acoustic positioning of the streamer. The navigation equipment may be placed in-line with the seismic sensors. However, insertion of navigation equipment in-line with seismic sensors will cause some of the seismic sensors to have irregular spacing (in other words, the spacing between a first pair of successive seismic sensors is different from the spacing between a second pair of successive seismic sensors). Complicated processing algorithms may have to be used to account for irregular spacings of seismic sensors.

### SUMMARY

In general, according to an embodiment, an apparatus for use in a marine environment includes a survey carrier structure, and survey sensors mounted along the survey carrier structure. Equipment is provided in-line with the survey sensors, where the equipment further includes at least another survey sensor. The survey sensors have regular spacing such that equidistant survey sensors are provided along the length of the survey carrier structure.

Other or alternative features will become apparent from the following description, from the drawings, and from the claims.

### BRIEF DESCRIPTION OF THE DRAWINGS

FIG. 1 illustrates an exemplary marine survey arrangement that includes a streamer having survey sensors and navigation equipment, in accordance with an embodiment.

FIG. 2 illustrates a portion of a streamer according to an embodiment.

FIG. 3 illustrates another portion of a streamer according to another embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

In accordance with some embodiments, a marine survey carrier structure is provided that includes survey sensors and navigation equipment placed in-line with the survey sensors. A marine survey carrier structure can be a streamer, cable, or other carrier structure on which are mounted survey sensors and other equipment. The navigation equipment is used to enable navigation (e.g., steering, positioning, etc.) of the carrier structure. In accordance with some embodiments, the navigation equipment includes one or more survey sensors in addition to components for performing navigation tasks.

In some embodiments, the survey sensors can be seismic sensors (e.g., hydrophones). Alternatively, the survey sensors can include electromagnetic (EM) sensors. A “survey sensor” is a sensor that is used to detect signals that are reflected from, or otherwise affected by, subterranean elements of a subterranean structure. A survey sensor differs from sensors used for other purposes, such as to perform positioning.

In the arrangement according to some embodiments, the survey sensors along the length of the survey carrier structure have regular spacing such that the survey sensors along the carrier structure are equidistant. In other words, the spacing between each successive pair of survey sensors along the survey structure is generally the same (to within manufacturing and assembly tolerances).

Placing navigation equipment “in-line” with survey sensors refers to navigation equipment mounted along the length of the survey carrier structure such that the navigation equipment affects the length of the carrier survey structure.

The navigation equipment that is placed in-line along the survey carrier structure can include a steerable bird (e.g., Q-Fin device from WesternGeco LLC, Houston, Tex.). The steerable bird can include fins that are rotatable with respect to a longitudinal axis of the steerable bird. The navigation equipment that is placed in-line with survey sensors can include multiple steerable birds placed at different points along the survey carrier structure.

In addition to a steerable bird, the navigation equipment can also include an acoustic positioning device that has an acoustic pinger to transmit high-frequency acoustic signals to perform acoustic positioning of the carrier survey structure. The acoustic positioning device further includes an acoustic receiver to receive reflected high-frequency acoustic signals such that acoustic positioning can be performed.

Conventionally, navigation equipment that is placed in-line with survey sensors along the survey carrier structure does not include survey sensors. As a result, placing such conventional navigation equipment in-line along the survey carrier structure will cause irregular spacings between survey sensors such that the survey sensors along the survey carrier structure are no longer equidistant. To address this issue, in accordance with some embodiments, navigation equipment inserted in-line along the survey carrier structure is provided with one or more survey sensors such that regular spacing of survey sensors along the length of the survey carrier structure can be achieved. In other words, the spacing of any pair of successive survey sensors (including survey sensors that are part of the navigation equipment and survey sensors that are not part of the navigation equipment but are mounted on the survey carrier structure) are generally the same. A pair of “successive” survey sensors refers to a pair of survey sensors that are provided along the carrier structure without any intervening survey sensor between the pair of survey sensors.

Although reference has been made to inserting navigation equipment in-line along the survey carrier structure, it is noted that other types of equipment (e.g., electronic modules, terminators, etc.) can also be inserted in-line along the survey carrier structure. Such other types of equipment can similarly be provided with one or more survey sensors such that regular spacing of survey sensors along the length of the survey carrier structure can be achieved.

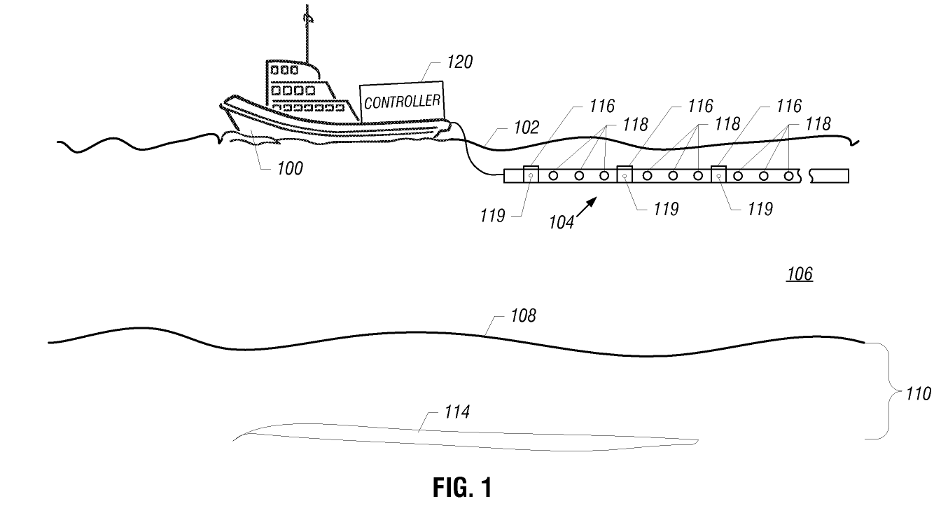

FIG. 1 illustrates an exemplary marine survey arrangement that includes a marine vessel 100 for towing a streamer 104 in a body of water 106 between a water surface 102 and a bottom surface 108 (sea floor). The streamer 104 includes survey sensors 118 and navigation equipment 116 placed in-line with the survey sensors 118. As noted above, in accordance with some embodiments, the navigation equipment 116 placed in-line with the survey sensors 118 includes survey sensors 119 to enable achievement of equal spacing between successive pairs of survey sensors along the length of the streamer 104.

Although not depicted in FIG. 1, the marine vessel 100 can also tow survey sources (e.g., seismic sources or EM sources) that are able to emit signals propagated through the body of water 106 and into a subterranean structure 110. Signals are reflected from one or more bodies of interest 114 in the subterranean structure 110, with the reflected signals received by survey sensors 118 and 119 in the streamer 104.

The marine vessel 100 also includes a controller 120 that is able to receive measured signals from survey sensors 118, 119. The controller 120 is able to process the measured signals to produce an output. Instead of being on the marine vessel 100, the controller 120 can alternatively be located at a different location.

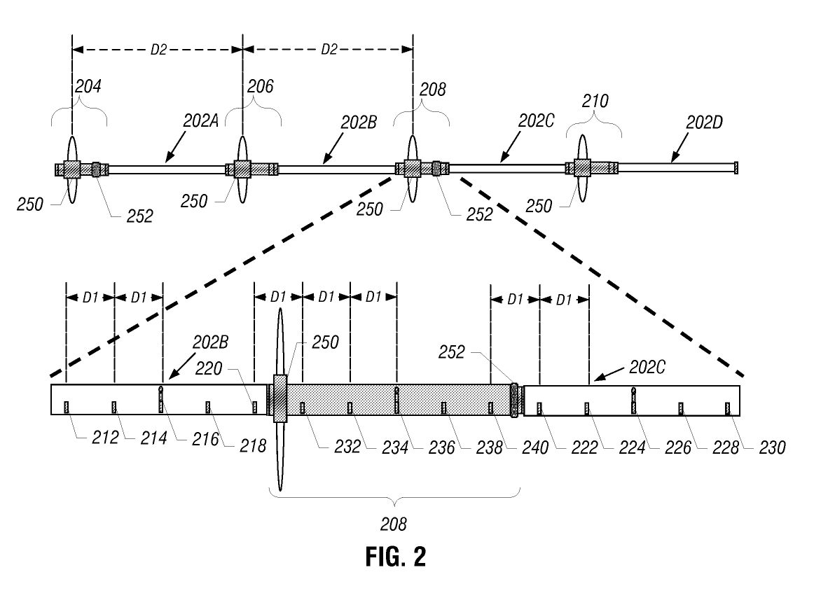

FIG. 2 shows a portion of a streamer that includes sensor assemblies 202A-202D, and navigation equipment assemblies 204, 206, 208, and 210. The navigation equipment assemblies 204 and 208 each includes a steering bird 250 and an acoustic pinger 252 to transmit high-frequency acoustic signals that are detected by a high-frequency acoustic sensor in the acoustic pinger 252 to perform acoustic positioning of the streamer. The navigation equipment assemblies 206 and 210 differ from navigation equipment assemblies 204 and 208 in that the navigation equipment assemblies 206 and 210 do not include acoustic pingers, but do include corresponding steering birds 250.

Each sensor assembly 202 (202A, 202B, 202C, or 202D) includes an external housing to contain a corresponding set of survey sensors (e.g., hydrophones).

A more detailed depiction of the navigation equipment assembly 208 and portions of the surrounding sensor assemblies 202B and 202C is provided in FIG. 2. As depicted, a portion of the sensor assembly 202B includes a subnet of survey sensors 212, 214, 216, 218, and 220, which contain seismic sensors like accelerometers, geophone or hydrophones. Each survey sensor may contain more that one type of seismic sensor and in any mix (e.g. hydrophone and accelerometers).

The sensor assembly 202C similarly includes a subnet of survey sensors 222, 224, 226, 228, and 230 that include corresponding seismic sensors.

The navigation equipment assembly 208 similarly includes survey sensors 232, 234, 236, 238, and 240 that include seismic sensors. The survey sensors 232, 234, 236, 238, and 240 are contained within an external housing of the navigation equipment assembly 208. The other navigation equipment assemblies 204, 206, and 210 similarly include corresponding external housings to contain respective survey sensors.

By placing survey sensors in the navigation equipment assembly 208, uniform or regular place spacing between successive pairs of survey sensors can be achieved along the length of the streamer. As depicted in FIG. 2, the spacing between every pair of successive survey sensors is D1 (e.g., the distance between survey sensors 212 and 214 is D1, the distance between survey sensors 214 and 216 is D1, the distance between survey sensors 220 and 232 is D1, the distance between survey sensors 232 and 234 is D1, the distance between survey sensors 240 and 222 is D1, and so forth). The distance between every pair of successive navigation assemblies is D2 (e.g., distance between navigation assemblies 204 and 206 is D2, distance between navigation assemblies 206 and 208 is D2, and so forth).

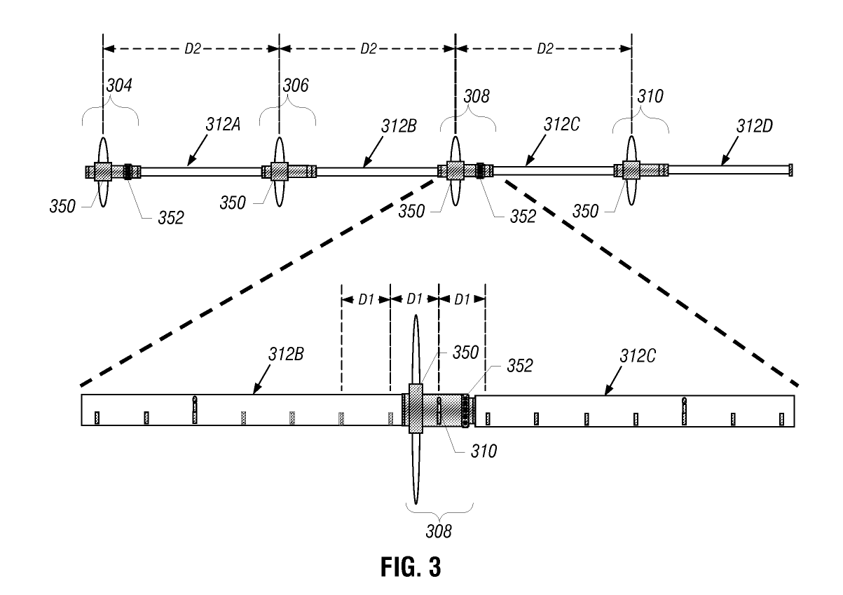

FIG. 3 shows an alternative embodiment that includes navigation equipment assemblies having reduced length (compared to the navigation equipment assemblies of FIG. 2). As depicted in FIG. 3, successive pairs of navigation equipment assemblies 304, 306, 308, and 310 are spaced apart along the length of the streamer by spacing D2. The navigation equipment assemblies 304 and 308 include steering birds 350 and acoustic pingers 352, whereas the navigation equipment assemblies 306 and 310 include steering birds 350 but not acoustic pingers. The navigation equipment assemblies 304, 306, 308, and 310 are spaced apart by corresponding sensor assemblies 312A, 312B, 312C, and 312D that contain respective sets of survey sensors.

As depicted in the blown-up portion of the navigation equipment assembly 308, a survey sensor 310 is incorporated into the navigation equipment assembly 308 such that the regular spacing of D1 can be achieved between each successive pairs of sensors. Note that the navigation equipment assembly 308 has a length that is shorter than the navigation equipment assembly 208 of FIG. 2. Therefore, the navigation equipment assembly 308 includes less survey sensors, as compared to the survey sensors in the navigation equipment assembly 208.

Other implementations aside from those depicted in FIGS. 2 and 3 are also possible. By incorporating survey sensor(s) into navigation equipment assemblies provided in-line along the streamer, regular spacings between successive pairs of survey sensors (e.g., hydrophones) can be achieved.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A subterranean survey apparatus for use in a marine environment, comprising:
a survey carrier structure;
first survey sensors mounted along the survey carrier structure; and
equipment inserted in-line with the first survey sensors, wherein the equipment further includes at least one second survey sensor,
wherein the first and second survey sensors are regularly spaced along a length of the survey carrier structure such that each pair of successive survey sensors are spaced apart by a regular distance.

2. The apparatus of claim 1, wherein the equipment comprises navigation equipment.

3. The apparatus of claim 1, wherein the survey carrier structure comprises a streamer for towing in a body of water.

4. The apparatus of claim 1, wherein the first and second survey sensors comprise seismic survey sensors.

5. The apparatus of claim 4, wherein the seismic survey sensors comprise accelerometers, geophones and/or hydrophones.

6. The apparatus of claim 1, wherein the first and second survey sensors comprise electromagnetic survey sensors.

7. The apparatus of claim 1, further comprising sensor assemblies along the survey carrier structure, each of the sensor assemblies containing respective sets of survey sensors, wherein each set of survey sensors includes any combination of one or more of a hydrophone, accelerometer, and geophone.

8. The apparatus of claim 7, wherein the equipment comprises navigation equipment assemblies, wherein each of the navigation equipment assemblies is positioned between a pair of sensor assemblies, and wherein each of the navigation equipment assemblies contains at least one survey sensor.

9. The apparatus of claim 8, wherein a distance between a successive pair of a survey sensor in one of the sensor assemblies and a survey sensor in one of the navigation equipment assemblies is equal to the regular spacing in the overall survey carrier structure.

10. The apparatus of claim 1, wherein the equipment further comprises a steering bird.

11. The apparatus of claim 1, wherein the equipment further comprises an acoustic pinger.

12. The apparatus of claim 1, wherein the equipment further comprises a terminator or an electronic module.

13. A marine survey carrier structure comprising:
sensor assemblies each containing a corresponding set of survey sensors; and
a navigation equipment assembly in-line with two of the sensor assemblies, wherein the navigation equipment assembly contains at least one survey sensor to enable the survey sensors along a length of the marine survey carrier structure to be regularly spaced.

14. The marine survey carrier structure of claim 13, wherein each pair of successive survey sensors along the marine survey carrier structure are spaced apart by a regular distance.

15. The marine survey carrier structure of claim 13, wherein the survey sensor in the navigation equipment assembly and a closest survey sensor in one of the sensor assemblies are spaced apart by a regular distance.

16. The marine survey carrier structure of claim 15, wherein each pair of successive survey sensors in each of the sensor assemblies are spaced apart by the regular distance.

17. The marine survey carrier structure of claim 13, comprising a streamer towable in a body of water.

18. The marine survey carrier structure of claim 13, wherein the navigation equipment assembly further includes a steering bird and/or acoustic pinger.

19. The marine survey carrier structure of claim 18, wherein the navigation equipment assembly further contains additional survey sensors.

20. The marine survey carrier structure of claim 19, wherein the survey sensors of the sensor assemblies and the navigation equipment assembly includes any combination of one or more of a hydrophone, geophone, and accelerometer.

21. The marine survey carrier structure of claim 13, further comprising:
an insert equipment assembly in-line with two of the sensor assemblies, wherein the insert equipment assembly contains at least one survey sensor to enable the survey sensors along a length of the marine survey carrier structure to be regularly spaced.

22. A method of performing a marine survey of a subterranean structure, comprising:
towing a survey carrier structure through a body of water, wherein the carrier structure includes sensor assemblies containing respective sets of survey sensors and navigation equipment, the navigation equipment further containing at least one survey sensor to enable each successive pair of survey sensors along a length of the survey carrier structure to be spaced apart by a regular distance; and
receiving measurement data at the survey sensors of the sensor assemblies and of the navigation equipment in response to signals affected by the subterranean structure.
